(19) United States
(12) Patent Application Publication
(10) Pub. No.: US 2025/0273374 A1
(43) Pub. Date: Aug. 28, 2025

(54) SYSTEM AND METHOD FOR ON-DEMAND VISCOELASTIC MULTI-INSTRUMENT CREATION

(71) Applicant: International Business Machines Corporation, Armonk, NY (US)

(72) Inventors: Mukundan Sundararajan, BANGALORE (IN); Anita Duggal, Delhi (IN); Saikat Mukhopadhyay, KOLKATA (IN); Kareem James Weller, Windermere, FL (US)

(73) Assignee: International Business Machines Corporation, Armonk, NY (US)

(21) Appl. No.: 18/585,392

(22) Filed: Feb. 23, 2024

(51) Int. Cl. H01F 7/06; G05B 15/02; H01F 1/44

(52) U.S. Cl. CPC H01F 7/064; G05B 15/02; H01F 1/44

(57) ABSTRACT

An embodiment determines a set of object parameters. The embodiment produces an object from a ferrofluidic viscoelastic material according to the object parameters. The embodiment generates a magnetic field to maintain a structure of the object. The embodiment captures physical feedback from a user interacting with the object through detecting a change in the magnetic field. The embodiment adjusts a strength of the magnetic field to continue to maintain the structure of the object. The embodiment receives an input command to cease maintaining the structure of the object. The embodiment adjusts the strength of the magnetic field to deform the object into a fluid.

### BACKGROUND

The present invention relates generally to peripheral computer devices. More particularly, the present invention relates to a method, system, and computer program for on-demand viscoelastic multi-instrument creation.

Computer peripheral devices are external computer components that extend the functionality of a computer beyond the computer's core processing unit. These external devices enable user interaction with a computer by providing additional input, output, and storage capabilities. Examples of peripheral devices include keyboards, mice, printers, scanners, monitors, external storage devices, and more. Input devices enable users to communicate with the computer, while output devices present information in a usable format. Peripheral devices expand the versatility and utility of computers and enable a user to perform a wide array of tasks and activities efficiently. As technology continues to advance, peripheral devices have evolved to meet the growing demands of users.

Viscoelastic materials exhibit a combination of viscous (flow-like) and elastic (spring-like) properties. The behavior of an object made from a viscoelastic material depends on the rate and duration of applied forces. When an object made from viscoelastic material is subjected to an applied force, the response of the object can be explained through two primary phenomena: creep and stress relaxation. When an object made from viscoelastic material is subjected to an applied force, the object may retain its solid form due to a combination of creep and stress relaxation. The material's ability to undergo gradual deformation and adjust its internal structure allows it to absorb and accommodate the applied forces over time without undergoing catastrophic failure or losing its solid characteristics.

### SUMMARY

The illustrative embodiments provide for a system and method for on-demand viscoelastic multi-instrument creation. An embodiment includes determining a set of object parameters. The embodiment also includes producing an object from a ferrofluidic viscoelastic material according to the object parameters. The embodiment also includes generating a magnetic field to maintain a structure of the object. The embodiment also includes capturing physical feedback from a user interacting with the object through detecting a change in the magnetic field. The embodiment also includes adjusting a strength of the magnetic field to continue to maintain the structure of the object. The embodiment also includes receiving an input command to cease maintaining the structure of the object. The embodiment also includes adjusting the strength of the magnetic field to deform the object into a fluid. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example network environment in accordance with an illustrative embodiment;

FIG. 3 depicts a block diagram of an example computing environment in accordance with an illustrative embodiment;

FIG. 4A depicts a block diagram of an example instrument creator apparatus in accordance with an illustrative embodiment;

FIG. 4B depicts a block diagram of an example instrument creator apparatus in accordance with an illustrative embodiment;

FIG. 5 depicts a perspective view of an example instrument creation apparatus in accordance with an illustrative embodiment;

FIG. 6 depicts a block diagram of an example instrument creator module in accordance with an illustrative embodiment; and

FIG. 7 depicts a flowchart of an example process for on-demand viscoelastic multi-instrument creation in accordance with an illustrative embodiment.

### DETAILED DESCRIPTION

External computer peripheral devices have vastly developed since the initial introduction of the computer. Today, peripheral devices, particularly input devices, have advanced to provide more functionality than original keyboards. Besides keyboards, there are various other input devices that enable a user to interact with a computer, such as mice, trackpads, touchscreens, joysticks, gamepads, controllers, and various biometric input devices. However, even given the vast array currently of existing keyboards and other input devices, user experience is still limited in part due to the design specifications of currently existing input devices that enable a user to interface with a computer.

Further, computer technology has developed to enable the ability to mediate and/or simulate many real-world activities. For example, remote surgery (also known as tele-surgery or robotic surgery) involves performing surgical procedures with the assistance of robotic systems controlled by a surgeon from a remote location using one or more remote control devices. The operating surgeon may manipulate one or more specialized control devices that replicate the surgeon's hand movements hand movements via a robotic system. Further, the robotic system may also provide the surgeon with haptic feedback, enabling the surgeon to feel resistance and pressure during the procedure.

However, despite the development of many specialized peripheral devices, the underlying problem remains that these devices are often complicated, highly specialized, not easily transportable, and provide limited functionality that might only be directed towards a particular task. Accordingly, there is a need to provide a system and method that enables on-demand creation of tools that is not limited by design specifications in the same manner that currently existing specialized instruments are limited.

The present disclosure addresses the deficiencies described above by providing a process (as well as a system, method, machine-readable medium, etc.) that provides on-demand viscoelastic instrument creation. Embodiments of the present disclosure enable creation and/or extension of a man-machine interface beyond keyboard and mouse devices and other currently existing peripheral devices to other instruments that enable new operations to be performed in different technologically evolving spaces of the digitized world. Further, embodiments of the present disclosure provide improved efficiency in performing various remote operations. Further, embodiments of the present disclosure provide increased precision of control and/or actions needed for better user interaction and communication in applications involving a man-machine interface.

An embodiment may act as a bridge between virtual and real instruments, enabling a user to create a virtual representation that corresponds to a real-world instrument, In an embodiment, a user can create a virtual prototype of an instrument to simulate and test different configurations and settings before applying them to a real-world instrument, which may reduce the risk of errors and optimize the performance of the real instrument. Further, an embodiment enables a user to tailor the virtual instrument according to specific needs and preferences. Further, this customization can be quickly applied to the real instrument, providing a personalized and efficient remote control experience. In an embodiment, a user can transmit their interactions with the virtual instrument to a remote center, where an expert can analyze the data and provide guidance or troubleshoot issues in real-time, such for example, in a scenario where expertise is not physically present at the location of the real instrument. Further, an embodiment facilitates rapid prototyping and iteration of control interfaces. A user may experiment with different control schemes in the virtual environment before implementing the most effective control scheme for the real instrument. Further, if a real instrument is located in a hazardous or inaccessible environment, a user can control the real instrument remotely from a safe and convenient location using the virtual instrument. Further, in an embodiment, the virtual instrument can provide real-time data feedback, allowing a user to monitor the impact of their interactions on the real instrument. Accordingly, the immediate feedback loop enhances control precision while remotely operating the instrument. Embodiments provide increased flexibility, customization, precision, and efficiency to the remote control of real instruments in various fields and scenarios.

The illustrative embodiments provide for on-demand viscoelastic instrument creation. An instrument as referred to herein is any tool that may be utilized by an end user to perform a task. Examples of instruments may include, but are not limited to, writing instruments, surgical instruments, hardware tools, etc. In addition to instruments, embodiments may also include creation of other interfaceable objects, including but not limited to, buttons, knobs, screws, etc. Embodiments disclosed herein describe the object created by example process disclosed herein as an instrument, however, use of this example is not intended to be limiting, but is instead used for descriptive purposes only. Instead, the object created by the example system and/or methods described may take on any physical form, and the exact form or shape of the object created is not limiting aspect of the present disclosure, but rather may be implementation specific, and/or dependent on user preferences during execution.

As used throughout the present disclosure, the term “viscoelastic material” refers to a material that may possess viscous as well as elastic properties depending on the force experienced by the material. Further, a viscoelastic material may be associated with a particular range of force, such that a select amount of force within that range will cause the material to harden, and exceeding a threshold amount of force may cause the material to soften. Further, an object made from viscoelastic material can retain its form over time through stress relaxation. Stress relaxation may include applying a constant deformation to the material and allowing the internal stresses to gradually decrease. By applying the proper amount of force over time, the material undergoes a controlled deformation while maintaining its overall shape. To begin the process, an external force is applied to the viscoelastic material, causing it to deform. This force can be applied gradually or as a step function, depending on the desired outcome.

Viscoelastic materials exhibit time-dependent behavior, meaning their response to applied forces depends on the duration of the force application. As the force is sustained, the material undergoes a gradual and time-dependent deformation. The material experiences stress relaxation, where the internal stresses within the material decrease over time while maintaining the constant applied deformation, due to the rearrangement of polymer chains or molecular structures within the material. By controlling the applied force and the duration of deformation, the viscoelastic material can retain its overall form. The gradual decrease in internal stresses allows the material to adjust to the applied force without undergoing deformation. Over time, the material may reach a state of equilibrium where the internal stresses have sufficiently relaxed, and the deformation stabilizes. At this point, the material retains its deformed shape without ongoing deformation. The proper amount of force and the duration of force application may be controlled to achieve the desired outcome. Applying too much force or maintaining the force for too long could lead to excessive deformation and/or failure of the material.

Further, to maintain the shape of an object made from viscoelastic material over time, a force may be applied in a controlled and sustained manner. Causing viscoelastic material object to retain a desired shape may include balancing the applied force and the time duration to allow the material to undergo stress relaxation without causing deformation. Further, the process may include continuously monitoring the deformation of the material as the force is applied via measurements or observations to ensure that the deformation remains within acceptable limits. Further, the process may adjust the magnitude of the applied force to achieve the desired level of deformation, including stabilization. Further, upon achieving a desired form, the process may maintain a constant overall force experienced by the object over time. This sustained force allows the material to undergo stress relaxation while retaining its overall shape. Depending on the application and material characteristics, the process of applying and releasing force may be repeated to achieve the desired shape retention over time. By controlling the applied force, monitoring deformation, and considering the time-dependent nature of viscoelastic materials, the shape of the object may be maintained over time through controlled stress relaxation.

As used throughout the present disclosure, the term “ferrofluid” refers to a liquid that becomes strongly magnetized in the presence of a magnetic field. A ferrofluid liquid may comprise nanoscale particles, such as magnetic iron compounds (e.g., magnetite), suspended in a carrier fluid, such as an oil or water-based solution. The unique controllable magnetic properties of a ferrofluid cause a ferrofluid to be useful in various applications, such as for example, enabling the form or shape of an object comprising a ferrofluid to be controlled by a magnetic field. Further, as used throughout the present disclosure, the term “ferrofluidic viscoelastic material” refers to a viscoelastic material that comprises ferrous elements suspended in the viscoelastic material. Embodiments of the present disclosure contemplate injecting a viscoelastic material with ferrous elements at precise determined selected locations for use in the creation of one or more objects whose shape may be controlled and maintained via a magnetic field, as described in greater detail herein.

Illustrative embodiments include a process that includes determining a set of object parameters for an object to be produced. In an embodiment, the process further includes producing an object from a ferrofluidic viscoelastic material according to the object parameters. In an embodiment, the process further includes generating a magnetic field to maintain a structure of the object. In an embodiment, the process further includes capturing physical feedback from a user interacting with the object through detecting a change in the magnetic field. In an embodiment, the process further includes adjusting a strength of the magnetic field to continue to maintain the structure of the object. In an embodiment, the process further includes receiving an input command to cease maintaining the structure of the object. In an embodiment, the process further includes adjusting the strength of the magnetic field to deform the object into a fluid.

Illustrative embodiments further include a method to determine the injection of a ferro fluidic embedded viscoelastic liquid through different shaped extruding profiles to create a desired instrument based on a desired operation to be performed. Illustrative embodiments further include determining shear force to convert to a viscoelastic solid that can be grasped by the user to perform the operation. Illustrative embodiments further include a method to determine the positions of the ferrofluid material when the extrusion process is carried out.

Illustrative embodiments further include a method to prepare the base device shape and/or surface for the operation. Illustrative embodiments further include a method to compute different physical actions related outcomes from the instrument and the base device during the operation.

Illustrative embodiments further include a method to track the shear force to ensure the viscoelastic solid shape is being maintained. Illustrative embodiments further include a method to modify the shear force to convert the viscoelastic solid to a fluid to be withdrawn back into the container after the user has indicated the completion of the operation.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

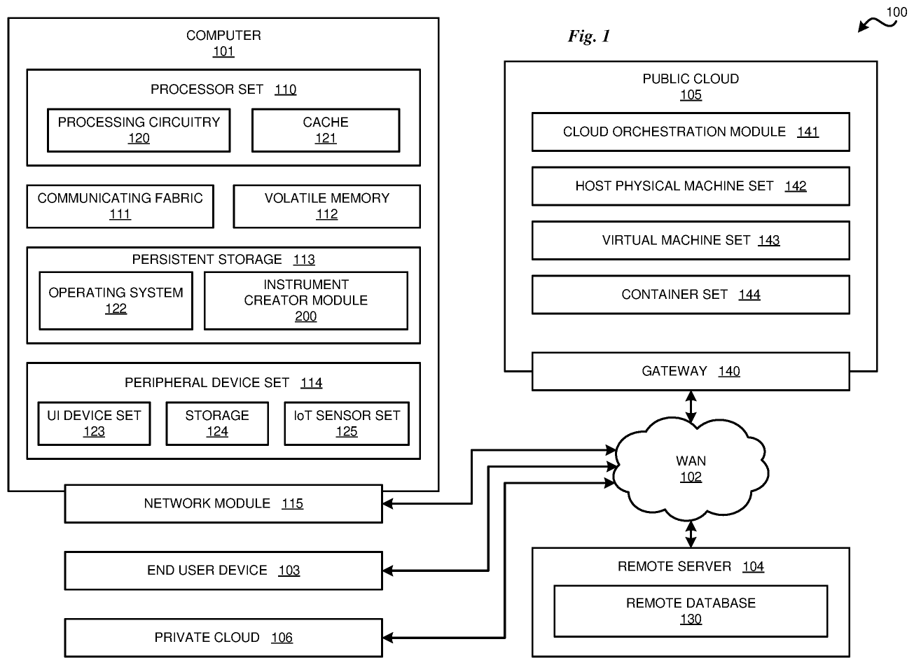

With reference to FIG. 1, this figure depicts a block diagram of a computing environment 100. Computing environment 100 contains an example of an environment for the execution of at least some of the computer code involved in performing the inventive methods, such as an instrument creator module 200 that provides instructions that when executed cause a system to create an object from a ferrofluidic viscoelastic material and maintain the structure of the object for a desired duration. In addition to instrument creator module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and instrument creator module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in instrument creator module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in instrument creator module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

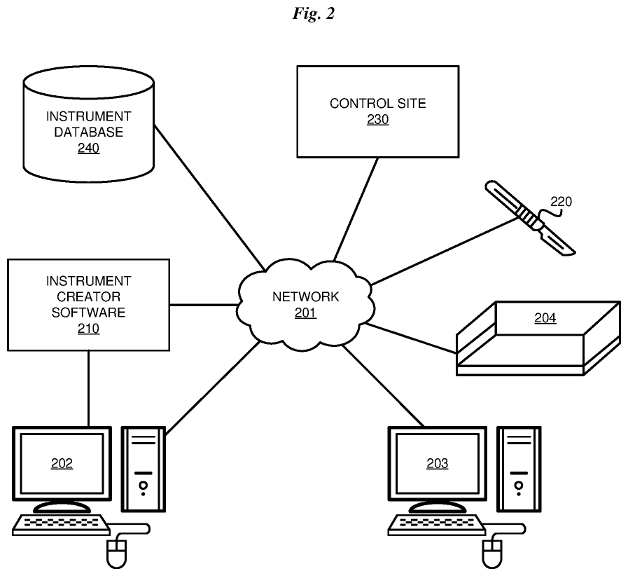

With reference to FIG. 2, this figure depicts a block diagram of an example network environment. In the illustrated embodiment, the instrument creator software 210 may include aspects of instrument creator module 200 of FIG. 1.

In the illustrated embodiment, the network environment depicted includes a user device 202, an administrator device 203, an instrument creator apparatus 204, an instrument 220 created via instrument creator apparatus 204, a control site 230, instrument creator software 210, and instrument database 240, all connected via network 201. In an embodiment, network 201 may include any suitable network architecture, such as for example, the Internet.

In the illustrated embodiment, the instrument creator apparatus 204 is configured to create an instrument 220. In an embodiment, the instrument creator apparatus creates the instrument 220 based on instructions sent from instrument creator software 210. In an embodiment, the instrument 220 is created out of a ferrofluidic viscoelastic material, as described in greater detail herein. In an embodiment, the process for creating the instrument via the instrument creator apparatus 204 may be generally performed as follows.

The instrument creator apparatus 204 may receive a set of object parameters from instrument creator software 210 that are input via a user device 202. The set of object parameters may be based on the stiffness necessary for an instrument to be used for a particular desired operation. Further, the set of object parameters may also include settings, including but are not limited to, the desired shape, the desired dimensions (e.g., length, width, thickness, etc.), grip type, as well as other settings related to the instrument to be produced and/or the operation for which the instrument is to be produced. In an embodiment, based on the object parameters determined, a set of parameters for extruding viscoelastic material from the fluid container of instrument creator apparatus 204, as well as a set of parameters for injection of ferro-drops within the viscoelastic structure of the object to be produced, are determined.

Further, based on some or all of the parameters determined related to the instrument to be created and/or operation to be performed, parameters related to the strength of a magnetic field are determined. The parameters related to the strength of the magnetic field may include, but are not limited to, the magnetic field strength, and horizontal pull arc of the magnetic field, and/or the vertical pull arc of the magnetic field.

Further, upon determination of some or all of parameters discussed, the instrument creator apparatus 204 produces an instrument 220 from a viscoelastic material that may be injected with ferro drops in select locations. In an embodiment, the instrument creator apparatus 204 generates a magnetic field via one or more magnetic field generating elements, as described in greater detail herein. The injection of the ferro drops into the viscoelastic material causes the viscoelastic material to become a ferrofluidic viscoelastic material, which may become magnetized in the presence of a magnetic field. When the object formed from the ferrofluidic viscoelastic material is produced, the magnetic particles suspended in the fluid may tend to align themselves along the lines of the magnetic field generated, which results due to the magnetic forces acting on the individual magnetic particles. In an embodiment, the shape of magnetic field generated via the one or more magnetic field generating elements combined with the location of the magnetic particles injected and suspended within the ferrofluidic viscoelastic material cause the object to be formed in a particular shape of a desired instrument 220. The computation of the exact shape of the magnetic field generated and the location of the magnetic particles within the viscoelastic material may be implementation specific and may dependent in part on the characteristics of the desired instrument to be produced and/or operation to be performed.

Further, in an embodiment, upon a user interacting with the instrument 220 that has been produced, changes to the magnetic field are detected and transmitted as input to the instrument creator software 210. Accordingly, the inputs transmitted to the instrument creator software 210 based on the changes made to magnetic field due to interacting the instrument 220 may be used to record, simulate, and/or replicate the action(s) performed. In an embodiment, the inputs are sent to a control site 230, and replicated via one or more robotic instruments or other components of the control site 230. Accordingly, the control site 230 may include any actual versions of the instrument 220 produced, such that may be remotely controlled via the instrument 220. In an embodiment, once a user has completed performance of an operation, the user may input a command indicating that the operation has been completed, which in turn may cause the instrument creator software 210 to execute instructions to alter the magnetic field generated in a manner to deform the instrument 220 back into fluid which may return to the fluid container of the instrument creator apparatus 204.

In the illustrated embodiment, the instrument database 240 is a database that may be established and/or configured to store data related to instruments. Accordingly, to facilitate the creation of objects based on input parameters, a instrument database 240 may be established to store and organize object parameters. In an embodiment, each record in this database represents a unique object. Further, each object may be associated with a unique object ID, which may comprise a unique identifier for each object. Further, any object parameters such as size, dimensions, thickness, stiffness, weight, and any other relevant attributes may be stored for each object. The instrument creator software 210 may retrieve data from instrument database 240, such as object parameters, to generate the desired object(s) based on user input. Further, in an embodiment, a record of each instrument created may likewise be created and stored on the instrument database 240, such that the record may include information including, but not limited, time of creation, location of creation, operation performed, duration of operation, location of operation performed, etc. In an embodiment, a digital signature based that may include some or all of the information on the record may likewise be created and stored on the instrument database 240 for each object created.

In the illustrated embodiment, the user device 202 enables a user to interact with instrument creator software 210 to create an instrument 220 via instrument creator apparatus 204. The user device 202 may include any type of computing device, including but not limited to, a desktop computer, a laptop, a tablet, a smartphone, an embedded system, a gaming console, a wearable device, an e-book reader, a thin client, or any other suitable computing device. Further, the user device 202 may include any peripheral devices to enable any combination of input and/or output functions. In an embodiment, user device 202 is integrated with instrument creator apparatus 204. In some other embodiments, user device 202 is a standalone computing device in communication with instrument creator apparatus 204. In some embodiments, user device 202 is in communication with instrument creator apparatus 204 via network 201. In some embodiments, user device 202 is in communication with instrument creator apparatus 204 via a data transmission cable that likewise may provide power to instrument creator apparatus 204. In the illustrated embodiment, administrator device 203 enables a user with sufficient administrative privileges to perform certain actions related to instrument creator software 210, instrument creator apparatus 204, and/or instrument database 240, as described in greater detail herein.

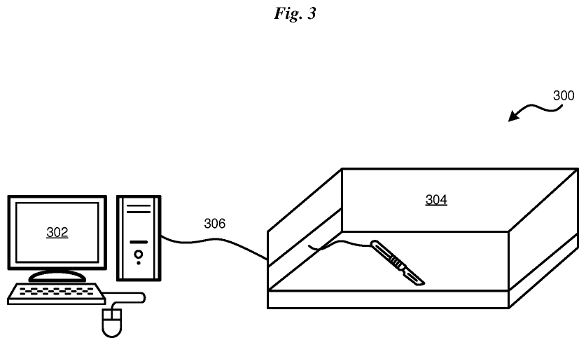

With reference to FIG. 3, this figure depicts an example computing environment 300 in accordance with an illustrative embodiment. In the illustrated embodiment, the user device 302 may include user device 202 of FIG. 2. In the illustrated embodiment, instrument creator apparatus 304 may include instrument creator apparatus 304 of FIG. 2. In the illustrated embodiment, the computing environment 300 depicts instrument creator apparatus 304 connected to user device 302 via a cable 306. In an embodiment, the cable 306 may include a data transmission cable and/or a power transmission cable 306, and/or a combination of both. In an embodiment, input commands entered via user device 302 are transmitted to instrument creator apparatus 304, as described in greater detail herein. In an embodiment, power is supplied from user device 302 to instrument creator apparatus 304 via cable 306, as described in greater detail herein. In an embodiment, the user device 302 comprises a portable computing device, such as a smartphone, which may be used to power a portable sized instrument creator apparatus 304, as well as used to transmit commands to instrument creator apparatus 304.

Although in the illustrated embodiment, user device 302 is depicted as separate from instrument creator apparatus 304, this is not intended to be a limiting aspect of the present disclosure. Instead, in some embodiments, user device 302 may be integrated into instrument creator apparatus 304, and may include, for example, a touchscreen to input commands to instrument creator apparatus 304. In an embodiment, instrument creator apparatus 304 may include any configuration of application-specific-integrated-circuits (ASICs), field-programmable gate arrays (FPGAs), central processing units (CPUs), or any other processing device configurations suitable to execute instructions based on input commands from a user.

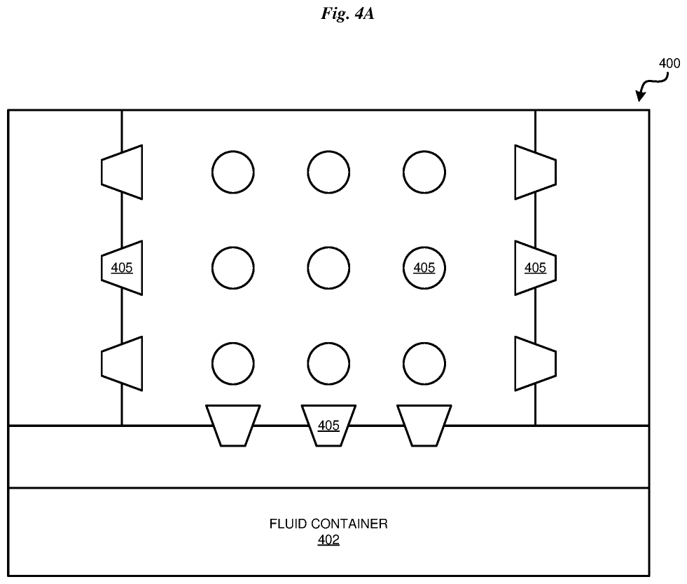

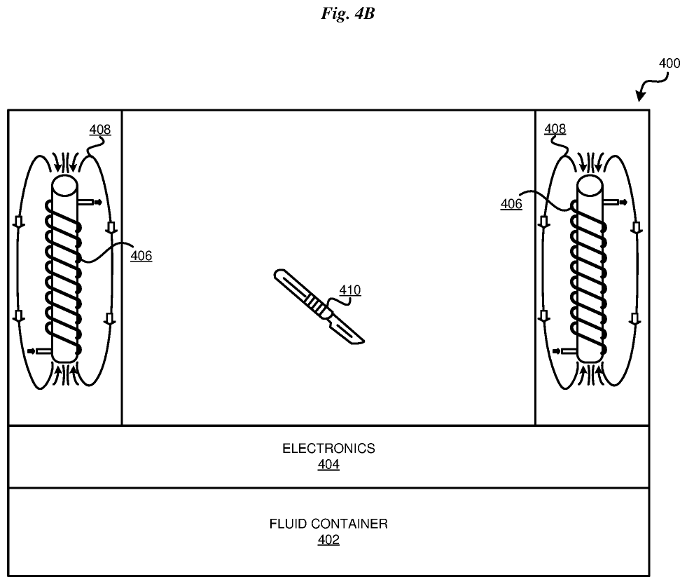

With reference to FIG. 4A, this figure depicts an example instrument creator apparatus. In the illustrated embodiment, the instrument creator apparatus 400 may include instrument creator apparatus 204 of FIG. 2, instrument creator apparatus 304 of FIG. 3, and/or instrument creator apparatus 400 of FIG. 4B.

In the illustrated embodiment, instrument creator apparatus 400 is depicted comprising a plurality of fluid ejection pumps 405 and a fluid container 402. Further, in the illustrated embodiment, the fluid container 402 is depicted as a storage for viscoelastic fluid. In an embodiment, the one or more fluid ejection pumps 405 draws viscoelastic fluid from fluid container 402 for use in production of a desired object. The exact configuration of the one or more fluid ejection pumps 405 may be implementation specific and is not limited to the arrangement depicted.

With reference to FIG. 4B, this figure depicts an example instrument creator apparatus. In the illustrated embodiment, the instrument creator apparatus 400 may include instrument creator apparatus 204 of FIG. 2, instrument creator apparatus 304 of FIG. 3, and/or instrument creator apparatus 400 of FIG. 4A.

In the illustrated embodiment, instrument creator apparatus 400 is depicted comprising a plurality of electromagnetic field generating elements 406. In an embodiment, the one or more electromagnetic field generating elements 406 are configured to generate a magnetic field upon execution of an instruction from instrument creator software. The exact configuration of the one or more electromagnetic field generating elements 406 may be implementation specific and is not limited to the arrangement depicted.

Further, the magnetic field(s) 408 may be generated by one or electromagnetic field generating elements 406 via an electric current flow through the one or electromagnetic field generating elements 406, which creates a magnetic field around the one or electromagnetic field generating elements 406. The strength and orientation of the magnetic field(s) 408 depend on the amount of current flowing through the electromagnetic field generating element 406 and the implementation specific characteristics of the specifications of the electromagnetic field generating element 406. When the electromagnetic field generating element 406 is activated, the magnetic field it produces interacts with the ferrous particles in the ferrofluidic viscoelastic material. Due to the magnetic properties of these particles, particles attempt to align themselves with the magnetic field lines. By controlling the current flowing through the electromagnetic field generating elements 406 and thereby adjusting the strength and orientation of the magnetic field(s) 408, it is possible to manipulate the shape and behavior of the ferrofluidic viscoelastic material from which the instrument 410 is created. Further, the force exerted by the magnetic field(s) may be used to maintain the structure of instrument 410 created from the ferrofluidic viscoelastic material. Accordingly, since an amount of force may be necessary to maintain the instrument 410 created, the magnetic field(s) 408 may provide the necessary amount of force to maintain the instrument 410.

In the illustrated embodiment, the instrument creator apparatus 400 may include one or more magnetic field sensors configured to detect the movement of the instrument 410. Since the instrument 410 is a ferrous object, detecting the movement of the instrument 410 may be achieved by monitoring changes in the magnetic field(s) 408 caused by the movement of the instrument 410 via one or more magnetic field sensors. In an embodiment, the one or more magnetic field sensors may include, but is not limited to, a Hall effect sensor, a magnetoresistive sensor, or another type of magnetic field sensor capable of detecting changes in magnetic flux, and/or any combination thereof. In an embodiment, the one or more magnetic field sensors is positioned in a vicinity of the magnetic field(s) 408 generated.

In the illustrated embodiment, the instrument creator apparatus 400 may include an electronics housing 404 that houses a portion of an electronic circuit configured to enable performance of operations disclosed herein. The circuit housed in the electronics housing 404 may include a combination of electronic components and sensors, as described in greater detail herein. In an embodiment, the electronics housing 404 contains various electronic components, including a microcontroller that processes sensor data and controls the various components based on the desired operations. In other embodiments, some or all of the data processing is performed remotely. A nonlimiting example embodiment of the circuit configuration may be achieved as follows. The magnetic field generating elements(s) 406 may be powered via a power supply circuit that may include a power source (e.g., a connected device, a battery, an AC power supply, etc.), a voltage regulator, and a switch for controlling the power to the magnetic field generating elements(s) 406.

Further, the circuit may include a magnetic field sensor configured to enable detection of movement of the instrument 410 based on changes detected to the magnetic field. The sensor output may be monitored by a microcontroller, which may process the signal to determine changes in the magnetic field indicative of movement. Further, the circuit may also include amplifiers or signal conditioning components to improve the sensitivity of the sensor, as would be known to one having skill in the art. Further, the microcontroller may include an Analog-to-Digital Converter (ADC) to convert changes detected in a magnetic field to digital information that can be processed by a computer, such as any computing device disclosed herein. For example, the magnetic field sensor (e.g., a Hall effect sensor, magnetoresistive sensor, etc.) produces an analog voltage signal that varies with changes in the magnetic field, which is fed into an Analog-to-Digital Converter. The ADC converts the continuous analog signal into a discrete digital representation. The digital output may comprise of binary information, i.e., a series of 1s and 0s representing the amplitude of the analog signal at a specific point in time. The digital output from the ADC may be processed by the microcontroller (or any other suitable computing device in connection with the apparatus) to analyze the digital data, perform calculations, and execute further instructions based on the changes in the magnetic field. Further, the binary information can be processed further, displayed, stored, or used for various control purposes. Accordingly, the ADC allows the conversion of analog signals, such as those from a magnetic field sensor, into digital information suitable for processing by a computing device. This conversion enables analysis, storage, and manipulation of the detected changes in the magnetic field corresponding to action taken on the instrument 510.

Further, the electronics housing 404 may further include portions of a pump control circuit to control pumps for viscoelastic material fluid flow. The pump control circuit may include a motor driver or relay to control the pump's power supply. Further, a microcontroller may be programmed to control the pump based on specific conditions or user inputs. The pump control circuit may further include a dispensing system configured to inject ferrous nanoparticles into select locations of the viscoelastic material dispensed. The dispensing system may include additional valves and/or actuators controlled by the microcontroller to regulate the flow of ferrous nanoparticles into the material fluid at specific points.

The actual circuit implementation may vary depending on the specific requirements of the systems and processes disclosed herein. Further, additional feedback mechanisms and/or user interface elements integrated into the overall system, that, although might not be described in detail, would be known to those having skill in the art.

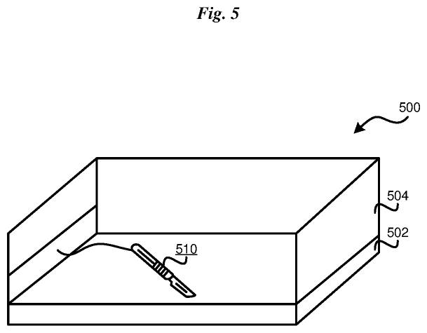

With reference to FIG. 5, this figure depicts a perspective view of an example instrument creation apparatus. In the illustrated embodiment, the instrument creator apparatus 500 may include instrument creator apparatus 204 of FIG. 2, instrument creator apparatus 304 of FIG. 3, and/or instrument creator apparatus 400 of FIG. 4A and FIG. 4B.

In the illustrated embodiment, the instrument creation apparatus 500 may be operated in the following example manner. First, the instrument creation apparatus 500 may be synchronized with a front-end device, such as any computing device described herein. Further, depending on the desired tool to be produced and/or operation to be performed, the instrument creation apparatus 500 determines the stiffness necessary for the tool(s), as well as the geometry and locations of the ferro-drops within the viscoelastic structure of the instrument 510. Further, based on input settings, and tool parameters (e.g., tool length, tool thickness, grip type of the tool, etc.) the instrument creation apparatus 500 begins of the extrusion of viscoelastic material and ferro fluid particles into select locations. Further, the instrument creation apparatus 500 establishes a magnetic field that is generated through magnetic field generating elements within walls 504 and/or base 502 of the instrument creation apparatus 500, as well as computes the magnetic field strength of the base and the vertical pull arc. Further, depending on the instrument to be created and/or operation to be performed, a base for the operation of the instrument is determined and created.

Upon creation of the instrument 510, a user carries out an operation using the instrument 510. The action(s) of the user interacting with the instrument 510 may be sensed from changes in the field detected via magnetic field sensors, and may be further processed as digital information, as described herein. In an embodiment, the action(s) of the user and measurements of the changes to the magnetic field may be simulated and displayed on a peripheral screen of a computing system connected to the instrument creation apparatus 500. Upon an indication from the user that the operation is complete, instrument creation apparatus 500 may increase magnetic stress on the on the instrument 510 formed from viscoelastic material which causes the instrument 510 to converts to a fluid state and collapses back into the base 502 of the instrument creation apparatus 500.

In an embodiment, the instrument creation apparatus comprises collapsible walls 504, such that the walls may be easily collapsed or opened via a hinge connecting each wall of the walls 504 to the base 502 of the instrument creation apparatus 500. In a particular embodiment, the entire instrument creation apparatus 500 comprises dimensions of approximately 10 cm×10 cm×10 cm. However, these dimensions are only example dimensions of a particular embodiment, and it is contemplated herein that the dimensions of the apparatus may be any size, depending on specific implementation.

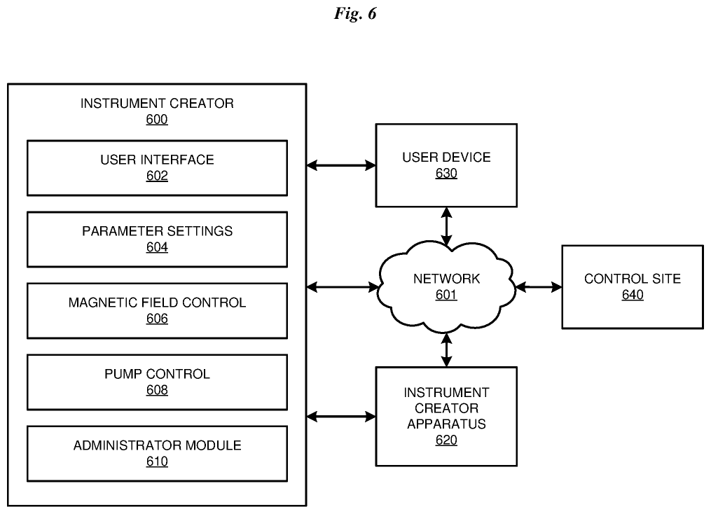

With reference to FIG. 6, this figure depicts a block diagram of an example instrument creator module 600 in accordance with an illustrative embodiment. In the illustrated embodiment, the instrument creator module 600 includes instrument creator module 600 includes instrument creator module 200 of FIG. 1.

In the illustrated embodiment, the instrument creator module 600 is a software module that includes a plurality of software modules, including but not limited to, a user interface module 602, a parameter settings module 604, a magnetic field control module 606, a pump control module 608, and an administrator module 610. In alternative embodiments, the instrument creator module 600 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the user interface module 602 is a software module configured to enable a user to input settings, instructions, commands, and/or control operations of instrument creator apparatus 620 via a user device 630. In the illustrated embodiment, the instrument creator apparatus 620 may include instrument creator apparatus 204 of FIG. 2, instrument creator apparatus 304 of FIG. 3, instrument creator apparatus 400 of FIG. 4A and FIG. 4B, and/or instrument creator apparatus 500 of FIG. 5. In the illustrated embodiment, the user device 630 may include any suitable computing device, such as for example, a desktop computer, or a smartphone device. In the illustrated embodiment, the instrument creator module 600, the user device 630, and the instrument creator apparatus 620 may all be in communication via network 601, which may include any suitable network, such as for example, the Internet.

In the illustrated embodiment, the parameter settings module 604 is a software module configured to calculate and set some or all of the parameters related to operations performed by the instrument creator apparatus 620. For example, some of the parameters that the parameter settings module 604 may compute and set, may include, but are not limited to, the following. One parameter the parameter settings module 604 may compute includes the pattern of actuation of pumps to flow viscoelastic material to form an object using the instrument creator apparatus 620. Another parameter the parameter settings module 604 may compute includes the pattern of actuation of injectors to inject ferrous nanoparticles in select locations of the material used to form the object. Another parameter the parameter settings module 604 may compute includes the strength of the magnetic field to initially generate. Further, the parameter settings module 604 may continuously compute the amount of electrical current needed to supply to create a magnetic field in response to user interaction with the object to maintain the structure of the object. For example, if a user is gripping the object with a certain amount of force, then the magnetic field may be adjusted to account for the amount of force that is already being supplied through the grip of a user. Another parameter the parameter settings module 604 may compute includes the activation pattern of magnetic field generating element(s) to provide shape of the magnetic field generated, depending on a desired instrument to be produced and/or operation to be performed. Although some of the parameters that the parameter settings module 604 may be responsible for computing and setting have been described, it is understood that the parameter settings module 604 may be responsible for computing and setting any parameters for any operations described herein.

In the illustrated embodiment, the magnetic field control module 606 is a software module that controls the magnetic field generated by the instrument creator apparatus 620 based on parameter settings computed by parameter settings module 604. In the illustrated embodiment, the pump control module 608 is a software module that controls various pumps and/or injectors actuated by the instrument creator apparatus 620 based on parameter settings computed by parameter settings module 604. For example, the pump control module 608 may control the pumps that flow viscoelastic material to form an object using the instrument creator apparatus 620. Further, the pump control module 608 may control the injectors that inject ferrous nanoparticles into the viscoelastic material in select locations. In the illustrated embodiment, the administrator module 610 allows users with administrative privileges to perform various administrative tasks and adjust any parameters and/or input settings associated with the processes as described herein.

In the illustrated embodiment, the instrument creator software module 600 is shown in communication with a remote control site 640 via network 601. In an embodiment, the actions performed by a user interacting with an object created by instrument creator apparatus 620 may be used as inputs to control elements of a remote control site 640. For example, suppose the object created by the instrument creator apparatus 620 includes a knob. When a user turns the knob, then an analog knob of an analog system existing in control site 640 may turn automatically to replicate the action performed of the user interacting with the knob created by instrument creator apparatus 620. As another example, suppose the instrument created by the instrument creator apparatus 620 includes a scalpel, and suppose the instrument creator apparatus 620 further creates a body part. In such a scenario, when a user makes an incision on the body part created by instrument creator apparatus 620 using the scalpel created by instrument creator apparatus 620, then a robotic device may create an incision at the same incision point of an actual body part of a person in remote control site 640. Although these hypothetical examples have been provided, it is contemplated herein that any action, operation, procedure, action, task, etc. may be remotely accomplished via the processes and systems described herein.

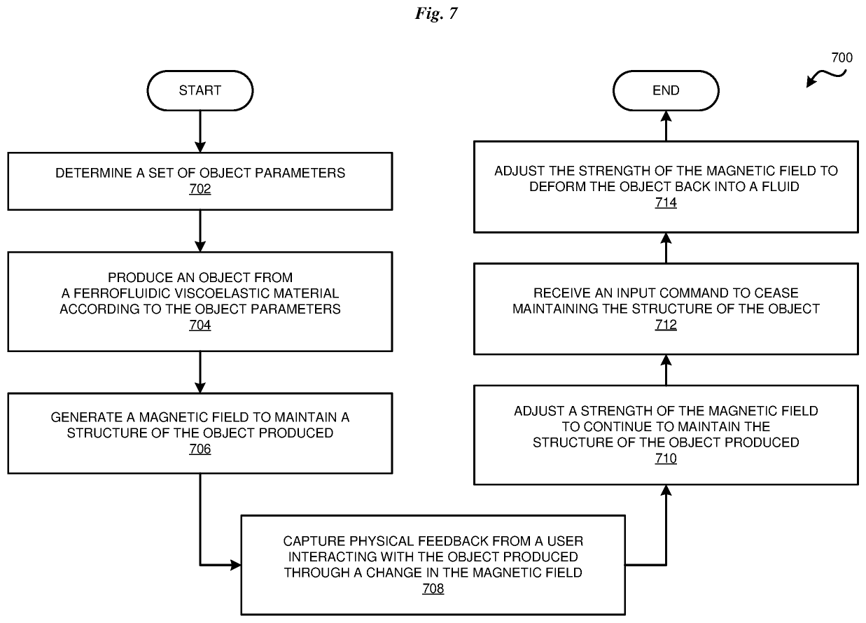

With reference to FIG. 7, this figure depicts a flowchart of an example process 700 for on-demand viscoelastic multi-instrument creation. In a particular embodiment, the instrument creator module 200 of FIG. 1 and/or the instrument creator module 600 of FIG. 6 carries out the process 700.

At step 702, the process determines a set of object parameters. At step 704, the process produces an object from a ferrofluidic viscoelastic material according to the object parameters. At step 706, the process generates a magnetic field to maintain a structure of the object produced. At step 708, the process captures physical feedback from a user interacting with the object produced through a change detected in the magnetic field. At step 710, the process adjusts a strength of the magnetic field to continue to maintain the structure of the object produced. At step 712, the process receives an input command to cease maintaining the structure of the object. At step 714, the process adjusts the strength of the magnetic field to deform the object back into a fluid.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
determining a set of object parameters;
producing an object from a ferrofluidic viscoelastic material according to the object parameters;
generating a magnetic field to maintain a structure of the object;
capturing physical feedback from a user interacting with the object through detecting a change in the magnetic field;
adjusting a strength of the magnetic field to continue to maintain the structure of the object;
receiving an input command to cease maintaining the structure of the object; and
adjusting the strength of the magnetic field to deform the object into a fluid.

2. The computer-implemented method of claim 1, further comprising transmitting an instruction to perform an operation at a remote control location based at least in part on the physical feedback captured from the user interacting with the object.

3. The computer-implemented method of claim 1, wherein capturing physical feedback from the user interacting with the object through detecting a change in the magnetic field is performed using a magnetic field sensor.

4. The computer-implemented method of claim 1, wherein adjusting the strength of the magnetic field to deform the object into a fluid comprises increasing the strength of the magnetic field above a threshold force to deform the object.

5. The computer-implemented method of claim 1, further comprising establishing an object database for storing one or more objects produced.

6. The computer-implemented method of claim 1, wherein the computer implemented is performed using an instrument creator apparatus, wherein the instrument creator apparatus comprises an integrated interface for inputting one or more commands.

7. The computer-implemented method of claim 1, wherein the computer-implemented method is performed using an instrument creator apparatus, wherein the instrument creator device is connected to a computing device, and wherein the computing device is configured to receiving one or more input commands to transmit to the instrument creator apparatus.

8. A computer program product comprising one or more computer readable storage media, and program instructions collectively stored on the one or more computer readable storage media, the program instructions executable by a processor to cause the processor to perform operations comprising:
determining a set of object parameters;
producing an object from a ferrofluidic viscoelastic material according to the object parameters;
generating a magnetic field to maintain a structure of the object;
capturing physical feedback from a user interacting with the object through detecting a change in the magnetic field;
adjusting a strength of the magnetic field to continue to maintain the structure of the object;
receiving an input command to cease maintaining the structure of the object; and
adjusting the strength of the magnetic field to deform the object into a fluid.

9. The computer program product of claim 8, wherein the stored program instructions are stored in a computer readable storage device in a data processing system, and wherein the stored program instructions are transferred over a network from a remote data processing system.

10. The computer program product of claim 8 wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, further comprising transmitting an instruction to perform an operation at a remote control location based at least in part on the physical feedback captured from the user interacting with the object.

12. The computer program product of claim 8, wherein capturing physical feedback from the user interacting with the object through detecting a change in the magnetic field is performed using a magnetic field sensor.

13. The computer program product of claim 8, wherein adjusting the strength of the magnetic field to deform the object into a fluid comprises increasing the strength of the magnetic field above a threshold force to deform the object.

14. The computer program product of claim 8, further comprising establishing an object database for storing one or more objects produced.

15. The computer program product of claim 8, wherein the instructions are executed using an instrument creator apparatus, wherein the instrument creator apparatus comprises an integrated interface for inputting one or more commands.

16. The computer program product of claim 8, wherein the instructions are executed using an instrument creator apparatus, wherein the instrument creator apparatus is connected to a computing device, and wherein the computing device is configured to receive one or more input commands to transmit to the instrument creator apparatus.

17. A computer system comprising a processor and one or more computer readable storage media, and program instructions collectively stored on the one or more computer readable storage media, the program instructions executable by the processor to cause the processor to perform operations comprising:
determining a set of object parameters;
producing an object from a ferrofluidic viscoelastic material according to the object parameters;
generating a magnetic field to maintain a structure of the object;
capturing physical feedback from a user interacting with the object through detecting a change in the magnetic field;
adjusting a strength of the magnetic field to continue to maintain the structure of the object;
receiving an input command to cease maintaining the structure of the object; and
adjusting the strength of the magnetic field to deform the object into a fluid.

18. The computer system of claim 17, further comprising transmitting an instruction to perform an operation at a remote control location based at least in part on the physical feedback captured from the user interacting with the object.

19. The computer system of claim 17, wherein capturing physical feedback from the user interacting with the object through detecting a change in the magnetic field is performed using a magnetic field sensor.

20. The computer system of claim 17, wherein adjusting the strength of the magnetic field to deform the object into a fluid comprises increasing the strength of the magnetic field above a threshold force to deform the object.
